(19) United States
(12) Patent Application Publication
(10) Pub. No.: US 2026/0243165 A1
(43) Pub. Date: Aug. 20, 2026

(54) RECONFIGURABLE DOWNHOLE SYSTEM FOR PH AND OTHER PARAMETERS FOR SUBSURFACE CARBON DIOXIDE STORAGE MONITORING

(71) Applicant: Expro North Sea Limited, Dyce (GB)

(72) Inventors: James Alexander Yard, Ringwood Hampshire (GB); Philip Stephen Karl Booker, Ringwood Hampshire (GB); Alan Thomson, Stirling (GB)

(21) Appl. No.: 19/054,457

(22) Filed: Feb. 14, 2025

(51) Int. Cl. E21B 49/08; E21B 41/00

(52) U.S. Cl. CPC E21B 49/0875; E21B 41/0064

(57) ABSTRACT

System and method for reconfigurable downhole sensor system for measurement and monitoring of pH in aquifers from which changes in carbon dioxide is inferred, is provided. The system includes pH sensing device and additional sensors for temperature, pressure, density, salinity, conductivity, viscosity and permittivity measurement, such that the architecture presents a concept for a flexible platform to address individual carbon dioxide storage and monitoring requirements. The sensing device is used for obtaining baseline measurements prior to commencement of carbon dioxide injection, during carbon dioxide injection operations and after carbon dioxide injection has ceased.

### BACKGROUND OF THE DISCLOSURE

### 1. Technical Field

The present disclosure relates generally to decarbonization technologies, applicable in the field of carbon capture and storage (CCS) for mitigation of climate change.

### 2. Background Information

Carbon capture and storage (CCS) is the process of capturing carbon dioxide from point source emissions, industrial processing or directly from the air and permanently storing it underground in geological formations. CCS is widely regarded as a critical decarbonization tool, which will support the journey to a net-zero CO₂ emissions future.

Environmental Protection Agency (EPA) has stringent regulations regarding reduction of carbon dioxide emissions which has propelled industries into devising systems and methods for monitoring carbon dioxide emissions. In the oil and gas industry, existing downhole sampling and monitoring methods do not adequately provide for continuous monitoring of aquifer geochemistry, which is vital in CCS projects. There is a need for a semi-permanent or permanent downhole pH sensors to detect changes in aquifer geochemistry, arising as a result of carbon dioxide injection at CCS projects, such as plume migration, leakage, migration, contamination monitoring, etc. The reaction between carbon dioxide and water results in the formation of carbonic acid, which impacts the pH levels of aqueous liquids. When carbon dioxide is dissolved in aqueous liquids, the release of hydrogen ions in carbonic acid lowers the pH of the aqueous fluids.

At present, there is a need for semi-permanent or permanent downhole pH and other sensors in the industry. pH is a critical measurement to monitor for changes in aquifer geochemistry, which infers mixing with CO₂ which would increase the acidity of the brine. Existing pH systems are designed for short term deployments only, and cannot be left in wells for extended periods of time, like for more than a month. EPA guidelines state that baseline surveys to understand aquifer geochemistry must be conducted periodically, in a systematic manner, before commencement of CO₂ injection operations. The frequency of the baseline surveys is further based on individual MMV plans presented to the regulator and local authorities. The current quarterly surveys, which are infrequent baseline surveys, do not deliver enough data density to generate a reliable baseline in which to use to monitor changes from. Semi-permanent or permanent downhole pH sensors and other sensors combined with pressure and temperature measurements would significantly increase data density, improve data quality and enhance the quality of the downhole measurement, monitoring, verification and reporting plans.

Consequently, there is a need for reliable and continuous data acquisition, including downhole pH, on carbon dioxide storage projects to improve the quality of measurement, monitoring and verification (MMV) plans. As there are a significant number of differing remote data gathering requirements for CCS projects, a flexible platform is required to provide downhole monitoring capabilities. Though pH is a useful indication of changes in aquifer conditions, combination with other measurements, e.g. temperature, pressure, density, salinity, conductivity, viscosity, permittivity, is potentially useful as well as is the capability to activate sampling apparatus and similar equipment. Requirements are developing with future sensing capabilities currently being defined. Durations vary from short term monitoring to longer term, so there is a need for long term or permanent monitoring with data being recorded either by onboard memory for later retrieval and potentially by using a wired or wireless transmission from the downhole sensor to the surface.

### SUMMARY

The present invention pertains to a reconfigurable downhole system for pH and other sensors for CO₂ storage operations using a common system CPU (central processing unit) and memory core and a reconfigurable common data bus to integrate to different sensors and peripherals. This system allows different types of pH sensors to be interfaced to address short, medium and long-term deployments. The system allows for additional sensors such as temperature, pressure, density, salinity, conductivity, viscosity and permittivity to be integrated as well as other equipment such as fluid samplers. The system further includes reconfigurable modes for recording or transmitting data such as local memory, via wireless communications and via wired communications. The system makes use of a common software plus firmware platform and architecture which is reconfigurable based on the functions required. The hardware uses a common connector across the platform to facilitate modular interfacing for additional sensors and functions and apparatus.

The present invention employs a unique reconfigurable downhole sensor system for measurement and monitoring of pH and other parameters such as temperature, pressure, density, salinity, conductivity, viscosity, permittivity, etc. in aquifers, such that the monitoring of these parameters provides a measurement of the acidity of the aquifer fluids from which changes in carbon dioxide can be inferred. The downhole sensing system can be used for multiple purposes in carbon capture and storage (CCS) projects including, downhole monitoring and surveillance in carbon dioxide storage projects.

The foregoing summary is intended merely to introduce a subset of the features more fully described in the following detailed description. Accordingly, this summary should not be considered as limiting.

### BRIEF DESCRIPTION OF THE DRAWINGS

The accompanying drawing, which is incorporated in and constitutes a part of this specification, illustrates an embodiment of the present teachings and together with the description, serves to explain the principles of the present teachings. In the figures:

FIG. 1 is a block diagram illustration of the internal high-level elements and their interface in the system.

FIG. 2 illustrates the carbon dioxide storage complex with potential device locations.

FIG. 3 illustrates a carbon dioxide injector well structure in accordance with an embodiment of the present invention.

FIG. 4 illustrates a monitoring well structure in accordance with an embodiment of the present invention.

### DETAILED DESCRIPTION

Reference will now be made in detail to embodiments of the present teachings, examples of which are illustrated in the accompanying drawing. In the drawings, like reference numerals have been used throughout to designate identical elements, where convenient. The following description is merely a representative example of such teachings.

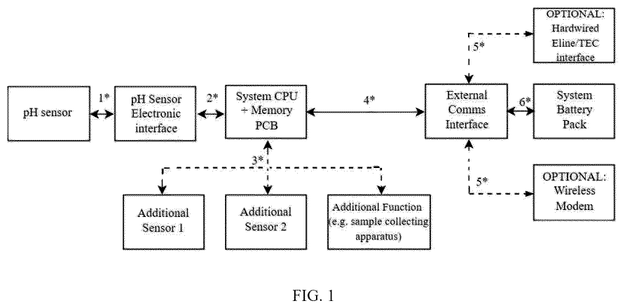

Embodiments of the present disclosure provide a system, method and apparatus for a reconfigurable downhole sensing device to measure pH in aquifers. The reconfigurable downhole sensor system has the ability to monitor different parameters during varying lengths of time on a range of well types with the same core system. Monitoring the pH of the aquifer fluids gives a measurement, from which changes in CO₂ can be inferred. The downhole pH sensor is combined with pressure and temperature measurements, which also aid in better monitoring of the changes in pressure front movements, formation integrity and fluid movements. Initially the device is battery powered and run in logging mode only (no telemetry). Data is downloaded at the well site when batteries are changed. There is an option to integrate with telemetry systems to provide real-time surface read out for future requirements. Power is either from surface cable permanent downhole gauge system (PDG system) or batteries (wireless gauge system). FIG. 1 illustrates the general components and interface of the internal high-level elements of the downhole sensor device 10. Interface 1* denotes the analogue/digital sensor electronic interface. Interface 2* denotes serial, I2C, SPI, CANBUS interface. Interface 3* is optional: analogue, serial, I2C, SPI, CANBUS interface. Interface 4* denotes serial, I2C, SPI, CANBUS interface. Interface 5* indicates optional: serial, I2C, SPI, CANBUS interface. Interface 6* denotes power distribution common backplane to all elements. This architecture provides a flexible platform to address individual Carbon dioxide storage and monitoring parameters as required, without requiring significant reengineering for each application.

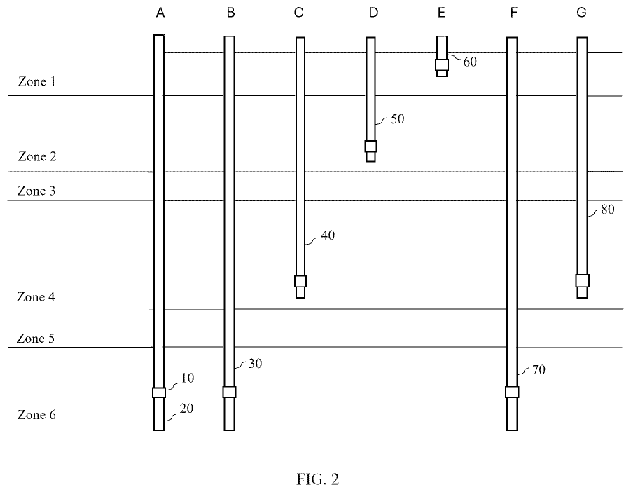

FIG. 2 illustrates an exemplary theoretical carbon dioxide storage complex with potential device locations. The sensor device 10 is shown installed in the potential device locations, classified into various zones: zone 1 is the Underground Sources of Drinking Water (USDW), zone 2 is the Above Confining zone which is shallow, zone 3 is below zone 2 and is the Secondary Confining zone, followed by zone 4 which is the Above Confining zone which is deep, followed by zone 5 which is the Primary Confining zone and lastly, zone 6 being the Injection zone. Wellbore A is the carbon dioxide injector well 20; Wellbore B is the monitoring well 30 shown within the injection zone 6; in Wellbore C the monitoring well 40 is shown above the primary confining zone, which is zone 4. Wellbore D is the monitoring well 50 shown above the secondary confining zone zone 2. In Wellbore E, the ground water well 60 is within USDW, which is zone 1. Wellbore F is the water producer well 70 in zone 6. Well bore G is the water producer well 80 in zone 4.

The sensor device 10 can be run on wire or it can be clamped onto tubulars. The device has the flexibility to be set below mechanical anchors (e.g. bridge plug, gauge hanger, packer, lock mandrel, etc.). The downhole system of the present invention is capable of providing accurate pH readings without the need for calibration for 3-6 months. This also has the potential for extended monitoring duration for greater than 6 months. This device can be installed in all well types in a CO₂ storage development, such as CO₂ injector wells 20, monitoring wells 30 in injection zone and monitoring wells 40 and 50, above the injection zone, groundwater well 60, boreholes and water producer wells 70 and 80. A pH sensor which is tested qualified at representative aquifer conditions (salinity, chlorides, P&T) is integrated with power and comms (e.g. integrated with other third party devices and systems) and is repackaged suitable for semi-permanent and permanent downhole deployment (e.g. housed in new or existing downhole enclosures). This device can be run as a standalone tool or in combination with other tools and devices. Redress or battery changes can be completed at the well site when the device is recovered.

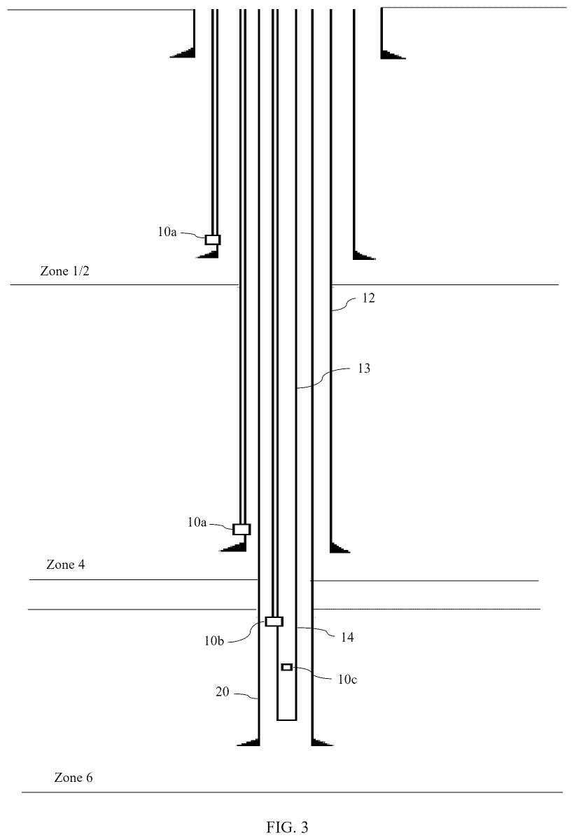

The sensing device is designed to be used for multiple purposes in carbon capture and storage (CCS) projects including, but not limited to, obtaining baseline measurements before CO₂ injection begins, from the injection aquifer, from the aquifers above the primary confining layer (primary seal) and from shallow aquifers, drinking water and groundwater sources. The downhole system can further be used for obtaining continuous measurements during CO₂ injection operations from the injection aquifer, from the aquifers above the primary confining layer (primary seal) and from shallow aquifers, drinking water and groundwater sources. Furthermore, the downhole system of the present invention can be used for obtaining measurements after CO₂ injection has ceased, from the injection aquifer, from the aquifers above the primary confining layer (primary seal), from shallow aquifers, drinking water and groundwater sources. These measurements support the creation of a robust measurement, monitoring and verification (MMV) plan, which is required to safely develop and operate carbon storage projects and report data to the regulators and local authorities. The downhole sensing device includes multiple measurements including, but not limited to pH, pressure and temperature. The sensing device would be suitable for short-term temporary deployments of up to 1-month, medium-term temporary deployments of up to 1 year, and long-term permanent deployments of greater than 1 year. The measured data can be stored on board the local device memory. The data can be downloaded and the device redressed when recovered to surface. The measured data can also be transmitted in real-time to surface by means of a telemetry system, through a cable, and/or wirelessly using acoustic or electromagnetic signals. The data can be transmitted in real time, for integration in data acquisition systems at surface. The downhole sensing device can be installed in any well type found within a carbon storage complex, including but not limited to CO₂ injector wells, monitoring wells within the injection zone, monitoring wells above the confining zone (deep and shallow), groundwater wells/boreholes (underground sources of drinking water USDW) and water producer wells. FIG. 3 illustrates a carbon dioxide injector well 20, denoting the downhole sensing device 10 installed in various zones. Zones 1 and 2 denote the underground sources of drinking water (USDW), zone 4 is above the primary confining zone, and zone 6 being the injection zone. The downhole sensing device 10a is run on the outer side of casing 12 as shown in zones 1, 2 and 4 of FIG. 3. The device 10b can be seen to run on completion 13. The device can be run on tubing or drill pipe (not shown). The device 10c is run inside tubing 14 as shown in zone 6 of FIG. 3.

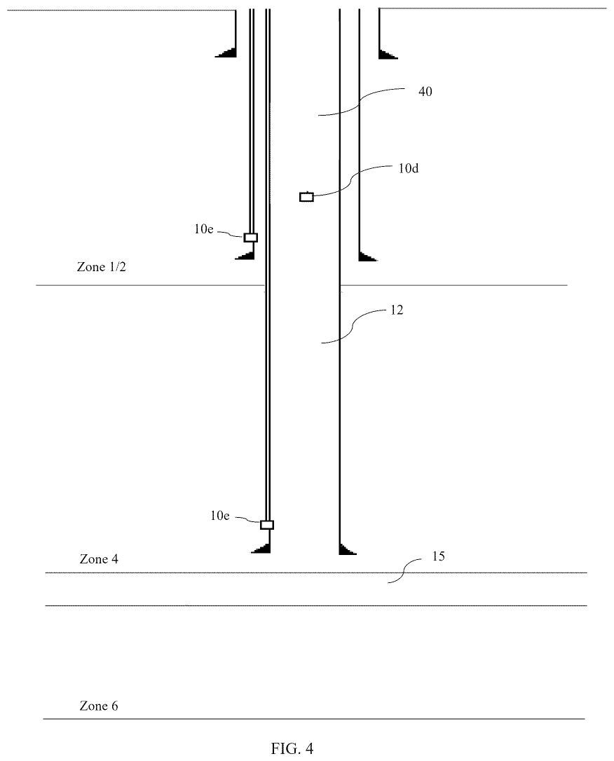

The device 10 is temporarily or permanently installed in wells and is set using a mechanical anchor or clamped onto tubing, and it can be recovered and redressed if required. The downhole sensing device 10 can be run in hole by various methods such as on wire (e.g. wireline, slickline, slick E-line, distributed fiber optic sensing intervention), on coiled tubing, on drill pipe, as a part of a completion, or clamped onto tubulars, tubing or casing. The downhole sensing device can be set in the well by various methods including but not limited to a gauge hanger, bridge plug, lock mandrel in nipple profile, or clamped onto tubulars (tubing or casing). FIG. 4 illustrates a monitoring well structure 40 above the Primary Confining zone which is deep, zone 4, showing how the downhole sensing device 10 is installed in various zones, and zone 6 being the injection zone. The downhole sensing device 10d is run inside the casing 12, and it can be run inside a drill pipe, or tubing as well. Or, the downhole sensing device 10e is run outside of the casing 12 in zones 1 and 2. The downhole sensing device 10e is run outside of the casing 12 in zone 4, with the primary seal 15 being below the casing 12, above the injection zone 6.

The foregoing describes preferred embodiments of the invention and is given by way of example only. The invention is not limited to any of the specific features described herein but includes all variations thereof within the scope of the appended claims.

1. A reconfigurable downhole sensor system for measurement of pH and other parameters of at least one of temperature, pressure, density, salinity, conductivity, viscosity and permittivity in an aquifer, comprising:
a pH sensing device, wherein,
the sensing device obtains baseline measurements prior to commencement of carbon dioxide injection;
the sensing device obtains continuous measurements during carbon dioxide injection operations; and
the sensing device obtains measurements after carbon dioxide injection has ceased; and wherein,
monitoring the pH provides a measurement of acidity of a fluid within the aquifer, from which changes in carbon dioxide is inferred.

2. The reconfigurable downhole sensor system of claim 1, wherein the measurements produce measured data that is used to support the creation of a robust measuring, monitoring and verification (MMV) plan, which is required for the development and operation of carbon capture and storage.

3. The reconfigurable downhole sensor system of claim 1, wherein the pH sensing device includes a plurality of sensors that are interfaced for short-term temporary, medium-term temporary and long-term permanent deployments downhole.

4. The reconfigurable downhole sensor system of claim 3, wherein the measurements produce measured data that is stored on board a local memory device and the data is downloaded and the device is redressed when recovered to the surface.

5. The reconfigurable downhole sensor system of claim 3, wherein the measurements produce measured data that is transmitted in real-time to the surface by means of a telemetry system, through a cable, or wirelessly using acoustic or electromagnetic signals, wherein, data is transmitted in real-time, for integration into data acquisition systems at the surface.

6. The reconfigurable downhole sensor system of claim 1, wherein the sensing device is installed in any well type found within a carbon storage complex, including carbon dioxide injector wells, monitoring wells within an injector zone, monitoring wells above a deep and shallow confining zone, ground water wells, boreholes, underground sources of drinking water (USDW) and water producer wells.

7. The reconfigurable downhole sensor system of claim 1, wherein the sensing device is temporarily or permanently installed in wells and set using a mechanical anchor or clamped onto tubing and is recovered and redressed as required.

8. The reconfigurable downhole sensor system of claim 1, wherein the sensing device is run into the well on wire, wireline, slickline, coiled tubing, distributed fiber optic sensing intervention, drill pipe or as a part of a completion.

9. The reconfigurable downhole sensor system of claim 1, wherein the sensing device is set in the well by gauge hanger, bridge plug, lock mandrel in nipple profile, or clamped on to tubulars, tubing or casing.

10. The reconfigurable downhole sensor system of claim 1, wherein the pH sensor and other sensors for a carbon dioxide storage environment use a common system central processing unit (CPU) and memory core and a reconfigurable common data bus to integrate to different sensors and peripherals.

11. The reconfigurable downhole sensor system of claim 1, wherein the sensor system has reconfigurable modes for recording and transmitting data, in local memory, via wireless and wired communications.

12. The reconfigurable downhole sensor system of claim 1, wherein the sensor system uses a common software and firmware platform and architecture which is reconfigurable based on one or more required functions; and wherein,
the hardware of the sensor system uses a common connector across the platform to facilitate modular interfacing for additional sensors and functions and apparatus.

13. A method comprising a reconfigurable downhole sensor system for measurement of pH and other parameters of at least one of temperature, pressure, density, salinity, conductivity, viscosity and permittivity in an aquifer, wherein the downhole sensor system includes a pH sensing device, the method comprising:
obtaining baseline measurements prior to commencement of carbon dioxide injection;
obtaining continuous measurements during carbon dioxide injection operations; and
obtaining measurements after carbon dioxide injection has ceased;
wherein monitoring the pH provides a measurement of acidity of a fluid in the aquifer, from which changes in carbon dioxide is inferred.

14. The method of claim 13, wherein the measurements produce measured data that is used to support the creation of a robust measuring, monitoring and verification (MMV) plan, which is required for the development and operation of carbon capture and storage.

15. The method of claim 13, wherein the pH sensing device includes a plurality of sensors that are interfaced for short-term temporary, medium-term temporary and long-term permanent deployments downhole.

16. The method of claim 13, wherein the measurements produce measured data that is stored on board a local memory device and the measured data is downloaded and the device is redressed when recovered to the surface.

17. The method of claim 13, wherein the measurements produce measured data that is transmitted in real-time to the surface by means of a telemetry system, through a cable, or wirelessly using acoustic or electromagnetic signals, wherein, data is transmitted in real-time, for integration into data acquisition systems at the surface;
the sensing device is installed in any well type found within a carbon storage complex, including carbon dioxide injector wells, monitoring wells within an injector zone, monitoring wells above a deep and shallow confining zone, ground water wells, boreholes, underground sources of drinking water (USDW) and water producer wells; and
the sensing device is temporarily or permanently installed in wells and set using a mechanical anchor or clamped onto tubing and is redressed and recovered as required.

18. The method of claim 13, wherein the sensing device is run into a well on wire, wireline, slickline, coiled tubing, distributed fiber optic sensing intervention, drill pipe or as a part of a completion.

19. The method of claim 13, wherein the sensing device is set in a well by gauge hanger, bridge plug, lock mandrel in nipple profile, or clamped onto tubulars, tubing or casing.

20. The method of claim 13, wherein the pH and other sensors for a carbon dioxide storage environment use a common system central processing unit (CPU) and memory core and a reconfigurable common data bus to integrate to different sensors and peripherals;
the sensors are interfaced for short, medium and long-term deployments downhole;
the sensor system has reconfigurable modes for recording and transmitting data local memory, via wireless and wired communications;
the sensor system uses a common software and firmware platform and architecture which is reconfigurable based on one or more required functions; and
the hardware of the sensor system uses a common connector across the platform to facilitate modular interfacing for additional sensors and functions and apparatus.
